(19) United States
(12) Patent Application Publication
(10) Pub. No.: US 2012/0241323 A1
(43) Pub. Date: Sep. 27, 2012

(54) Previously entitled "FLUID TREATMENT METHOD AND SYSTEM USING FLOWING GENERATOR TO TREAT WATER" herein amended to "FLUID TREATMENT"

(75) Inventor: Michael Manion, Cronulla (AU)

(73) Assignee: Empire Technology Development LLC, Wilmington, DE (US)

(21) Appl. No.: 13/146,597

(22) PCT Filed: Mar. 24, 2011
(86) PCT No.: PCT/US11/29769

§ 371 Date: Jul. 27, 2011

(51) Int. Cl. C02F 1/48; C02F 1/32; C02F 1/42

(52) U.S. Cl. 204/554; 204/660; 210/243

(57) ABSTRACT

Herein provided are methods, kits, systems, devices, etc. relating to the use of electrical energy for the treatment of fluids.

### TECHNICAL FIELD

The present disclosure generally relates to fluid treatment.

### BACKGROUND

Bacteria and other organisms can grow and thrive in various fluids. In some situations, the risks relating to such contaminants are addressed through filtration or disinfection using chemicals or UV light.

### SUMMARY

In some embodiments, a fluid treatment system is provided. The fluid treatment system can include an electroporation chamber that can include an anode and a cathode configured to provide an electrical potential within or across the electroporation chamber. The system can also include a flow generator in fluid communication with the electroporation chamber. In some embodiments, the flow generator generates electricity by movement of a fluid, and the flow generator can be electrically coupled to the anode and to the cathode to provide the electricity for the electrical potential. In some embodiments, the system can include a pulse generator that can be electrically coupled to the flow generator, the anode, and/or the cathode.

In some embodiments, the pulse generator and the flow generator are configured to provide an electric field of at least 10 mV/cm. In some embodiments, the pulse generator and the flow generator are configured to provide an electric field between 1 kV/cm and 100 kV/cm. In some embodiments, the pulse generator and the flow generator are configured to provide at least 10 amperes of current across the electroporation chamber. In some embodiments, the pulse generator can be configured to provide pulses at a frequency and duration such that multiple pulses are provided to a section of fluid as the section of fluid flows through the electroporation chamber. In some embodiments, the electroporation chamber includes a pipe. In some embodiments, the pipe includes a cylinder. In some embodiments, an interior of the electroporation chamber can be defined by a first inner surface that can include the anode and a second inner surface that can include the cathode. In some embodiments, the anode can be separated from the cathode by an insulating section. In some embodiments, the electroporation chamber defines an outer surface of a flow path through which a fluid flows. The anode or the cathode can be positioned within the flow path. In some embodiments, the anode can be a wire or a metal plate within the flow path, and the cathode can be a surface of the electroporation chamber. In some embodiments, the cathode can be a wire or a metal plate within the flow path and the anode can be a surface of the electroporation chamber. In some embodiments, the system also includes a capacitor. In some embodiments, the capacitor can be part of a pulse generator. In some embodiments, the system also includes a UV light source that can be electrically connected to the flow generator. In some embodiments, the system also includes a fluid within the electroporation chamber. In some embodiments, the system also includes a fluid within the flow generator. In some embodiments, the fluid within the electroporation chamber can be a same body of fluid as the fluid in the flow generator. In some embodiments, the electroporation chamber contains grey water. In some embodiments, the system also includes a sedimentation chamber in fluid communication with the electroporation chamber. In some embodiments, the anode, the cathode, or the anode and the cathode can include titanium, aluminum, copper, or any combination thereof. In some embodiments, the system also includes a deionising resin located upstream to the electroporation chamber. In some embodiments, the fluid can include osmotic agents, calcium, hypertonic additives, biocidal additives, microbe growth inhibiting additives, or any combination thereof. In some embodiments, the system can be configured to deliver AC current between the cathode and the anode. In some embodiments, the system can be configured to deliver DC current between the cathode and the anode. In some embodiments, the electroporation chamber further includes an exterior nonconducting shell. In some embodiments, the electroporation chamber can be level. In some embodiments, the electroporation chamber includes a proximal end and a distal end. The distal end of the electroporation chamber can be lower than the proximal end of the electroporation chamber. In some embodiments, the electroporation chamber includes a proximal end and a distal end, and the distal end of the electroporation chamber can be higher than the proximal end of the electroporation chamber.

In some embodiments, a fluid treatment kit is provided. The kit can include a flow generator; a pulse generator, and an anode in electrical communication with the flow generator. The current in the anode can be controlled by the pulse generator. The kit can also include a cathode in electrical communication with the flow generator. The current in the cathode can be controlled by the pulse generator. In some embodiments, the flow generator and pulse generator can be configured so as to provide a pulse of at least 1 kV at 10 Amps.

In some embodiments, a method for treating water is provided. The method can include flowing water through a generator to generate electrical power. The water can contain a cell. The method can also include using a pulse generator to transform the electrical power into a pulse of electricity and applying the pulse of electricity to the water in a sufficient current and at a sufficient voltage to lyse the cell to treat the water. In some embodiments, the section of water that generates the electrical power has the pulses of electricity applied to it. In some embodiments, the method also includes applying a second and a third pulse of electricity. In some embodiments, a frequency of the pulse of electricity can be determined by a flow rate of the flowing water. An increase in the flow rate can result in a greater frequency of the pulse and a decrease in the flow rate can result in a lower frequency of the pulse. In some embodiments, at least two pulses of electricity having a voltage of at least 1 kV at 10 amps are applied to the water.

In some embodiments, a method of electrifying water is provided. The method can include providing a flow powered electroporation device. The device can include an electroporation chamber including an anode and a cathode configured to provide an electrical potential within or across the electroporation chamber and a flow generator in fluid communication with the electroporation chamber. The flow generator generates electricity by movement of a fluid, and the flow generator can be electrically coupled to the anode and to the cathode to provide the electricity for the electrical potential. The method can further include flowing water through the flow generator to generate the electrical potential, and applying the electrical potential to the anode and the cathode so as to generate one or more pulses of electricity across the water, thereby electrifying the water.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a depiction of some embodiments of a fluid treatment system.

FIG. 2 is a depiction of some embodiments of a fluid treatment system being employed with additional components.

FIG. 3 is a flow chart depicting some embodiments for how a fluid treatment system can be employed.

FIG. 4 is a flow chart depicting some embodiments for how a fluid treatment system can be employed.

FIG. 5 is a flow chart depicting some embodiments for how a fluid treatment system can be employed.

### DETAILED DESCRIPTION

Provided herein are various embodiments of methods and devices that can be used to treat a fluid. In some embodiments, this involves the use of a flow generator associated with an electroporation chamber. The device and/or system can be used with a flowing fluid so that the kinetic energy contained within the flowing fluid may be used to power the flow generator and thus create electricity to power the electroporation chamber. In some embodiments, one or more pulses of electricity can be applied in the electroporation chamber to electroporate at least one cell within the fluid.

In some embodiments, the method for treating a fluid involves flowing a section of water through the electroporation chamber and applying pulsed electric shocks to the section of water to irreversibly electroporate at least one living organism or cell in the water. This can assist in effectively disinfecting the water or other fluids. Energy for producing the pulsed electric shocks can be made from the water flowing into the system through the flow generator (which can be integrated into the system).

The following detailed description outlines various aspects of electroporation, it then provides a detailed description of various embodiments of fluid treatment systems and how they can be used. The description then provides additional variations and alterations for various aspects and then concludes with an Examples section.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

### Electroporation

In some embodiments, electroporation is a dynamic phenomenon that causes permeabilization of a cell membrane by exposing the cell to an electric pulse. The effectiveness of this depends on the local transmembrane voltage at each point on the cell membrane. The pulse strength, the pulse duration, and the pulse shape determine, at least in part, the manifestation of the electroporation phenomenon in the cell. These properties can lead to no effect on the cell membrane, reversibly open the cell membrane after which the cells can survive, or irreversibly permeabilize the cell membrane that leads to cell death. The electric field changes the electrochemical potential across the cell membrane and induces instabilities in the polarized cell membrane lipid bilayer. The unstable membrane then alters its shape, forming aqueous pathways through the membrane. Mass transfer then occurs through these channels under electrochemical control. Cells that are in areas where E≧Eₜₕ are electroporated (where E is the electric field, and Eₜₕ is the threshold magnitude electric field). If a second threshold (Eᵢᵣ) is reached or surpassed, electroporation will compromise the viability of the cells, e.g., irreversible electroporation.

Pulsed electric field (PEF) technology has been through FDA approvals and used in place of thermal pasteurization (Ramaswamy et al. “Pulsed Electric Field Processing, Fact Sheet for Food Processors,” Extension FactSheet, Food Science and Technology, 2015 Fyffe Road, Columbus Ohio 43210-1007, FSE-2-05, from the Ohio Stat University Extension) PEF works well with juices and can also be used for beer, wine, yogurts, and salad dressings. The media should be pumpable (e.g., a liquid or slurry). While PEF offers a 5-log reduction of most pathogens, it is considered a pasteurizing process, so the product is refrigerated. One advantage of PEF is to avoid the loss of flavor from normal thermal pasteurization. As the present technology can be applied for waste fluid treatment or general treatment of any fluid, there is no need for any product to be refrigerated.

In some embodiments, PEF applies a strong electric field on a flowing fluid for a very short time. Above a critical field strength of about 15 kV/cm, vegetative cells are killed. Electric fields up to 35 kV/cm can destroy bacteria, fungi and other microbes. PEF can break down cell walls. Another use for PEF is the extraction of juice from plant materials such as sugar beets or grapes.

### Fluid Treatment Systems and Devices

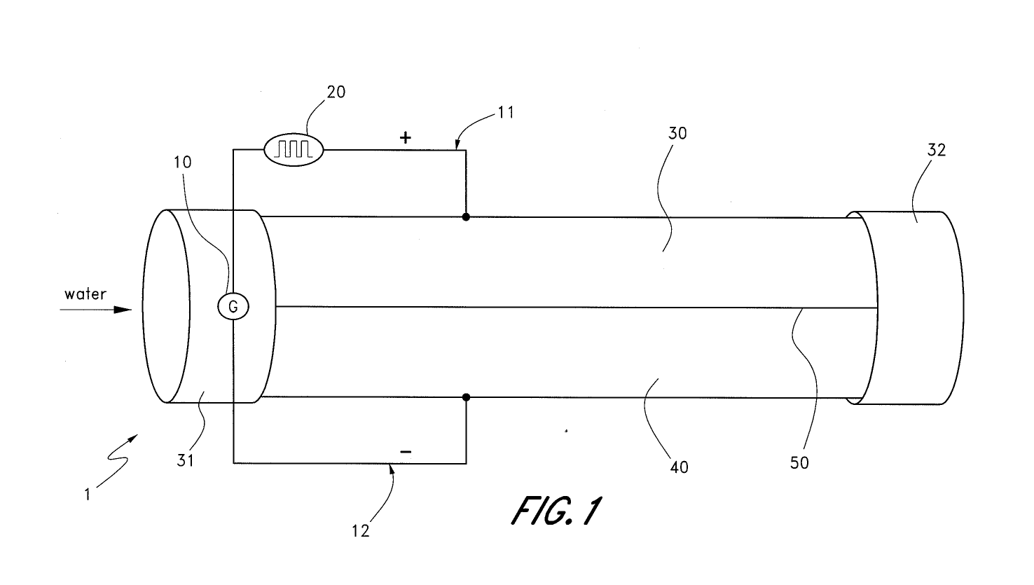

FIG. 1 depicts some embodiments of a fluid treatment system or device 1. As shown in FIG. 1, the system or device 1 can include a flow generator 10 that is positioned upstream of a cathode 30 and an anode 40. The flow generator 10 is in electrical communication with the cathode 30 and the anode 40 so that electricity generated by the flow generator 10 can be delivered to the cathode 30 and the anode 40. The device 1 can also include an insulating layer or midsection 50. In some embodiments, the flow generator 10 is connected to the electrodes 30 and 40 via a first lead or wire 11 and a second lead or wire 12, respectively. In some embodiments, the anode 40 and the cathode 30 are kept together (with the insulating midsection) via a band or circular section 31 and 32.

In the embodiments of FIG. 1, the cathode 30 is a top half of the piping and the anode 40 is a bottom half of the piping, so that when they are combined they form a complete section of piping. In some embodiments, the anode and the cathode may be separated by an insulating layer or midsection 50. This type of arrangement, where the anode and the cathode form an exterior shell that surrounds the fluid, allows for the current to flow across an entire flow path of the fluid. In other embodiments, the cathode and/or the anode can be located within the flow path of the fluid (rather than defining the exterior surface of the flow path) with the understanding that not all of the fluid need pass between the two electrodes.

In some embodiments, the cathode 30 and anode 40 are made of a conductive material, such as copper, iron or a conductive polymer. In some embodiments (such as the one depicted in FIG. 1), the anode and the cathode combination is held together by a band or clamping section 31 and 32 of the rest of a piping system, which can be cemented in place. In other embodiments, the band or clamping sections 31 and 32 are separate rubber or plastic rings and can hold the anode and the cathode together (separated by the insulating midsection) even when the device or system is not installed into the piping system. In some embodiments, the band or clamping sections are the ends of the rest of the piping of a system into which the present device is to be inserted.

In some embodiments, the device or the system further includes the pulse generator 20 in electrical communication with the flow generator 10 and at least one of the cathode 30 or the anode 40. In some embodiments, the pulse generator controls the application of the electricity to the anode and/or the cathode. In some embodiments, the pulse generator is integrated into the flow generator, the anode, the cathode, or some combination thereof. In some embodiments, the pulse generator creates the adequately strong electric field across the anode and the cathode (which can be across the piping section, as shown in FIG. 1), in order to effectively administer an electrical current to the fluid. In some embodiments, the pulsing is adequate to electroporate at least one organism and/or cell present in the fluid. In some embodiments, a voltage being applied is between 1-10 kV with greater than 10 amperes of current. In some embodiments, the device and/or the system is configured to produce the electric field where E≧Eᵢᵣ, thereby resulting in an “irreversible” electroporation. “Irreversible electroporation” denotes that the cell or other membrane has had its membrane altered so as to weaken and/or reduce its integrity, and in some embodiments, kill the cell or otherwise inhibits growth. In some embodiments, the irreversible electroporation is a nonthermal electroporation. In some embodiments, the irreversible electroporation results in cell death within 1, 2, 3, 4, 5, 6, 7, 8, 9, 10, 11, 12, or 24 hours. In some embodiments, the irreversible electroporation weakens the cell so as to prevent or reduce any further cellular proliferation. In some embodiments, the device and/or the system is configured to produce the electric field where E≧Eₜₕ, thereby resulting in a “reversible” electroporation. “Reversible electroporation” denotes that the cell and or other membrane has had its membrane temporarily altered so as to weaken and/or reduce its integrity, and in some embodiments, kill the cell. For example, if the temporary permeability allowed for the influx of compounds which kill the cell (either normally present, or added to the fluid), or otherwise compromised the physiology of the cell leading to its death or otherwise inhibits growth,

In some embodiments, the pulses are generated at a sufficient frequency, shape and a duration compared to a flow rate such that the fluid receives multiple pulses of electricity as it passes through the section. In some embodiments, this enhances an efficacy of the disinfection. In some embodiments, this is modulated such that the frequency, shape and/or the intensity of the electric fields delivered are variable and controlled by a flow and a turbidity sensor, or matched to a particular use for the fluid coming out of the system.

In some embodiments, the electricity for the system is generated by the system itself so as to provide a self-contained system. Thus, the fluid coming through the piping is used to create electricity (via the flow generator) that is then supplied to the pulse generator. In some embodiments, the electricity is stored in the pulse generator 20 until such time as it is sufficient to supply an electric shock to the fluid passing through the electrophoresis chamber. In some embodiments, this energy storage can be accomplished through the use of a capacitor.

In some embodiments, the combination of the flow generator and the electrodes allows for electricity to be generated by the fluid in a self-contained and a self-modulating system. In some embodiments, the faster the fluid flows, the more energy is created for electroporating the cells and/or the organisms in the fluid. In some embodiments, the shape of the flow generator can narrow so as to increase the amount of energy derived from the fluid. In some embodiments, the shape electroporation chamber can narrow to increase the amount of energy delivered to the fluid. In some embodiments, the cross sectional area of the flow path can be 99, 98, 97, 95, 90, 85, 80, 70, 60, 50, 40, 30, 20, 15, 10, 5, 4, 3, 2, 1% or less of the cross sectional area of the flow path prior to entry into the present device (or coming into contact with the flow generator or the electroporation chamber), including any range less than any of the preceding values and any range defined by any two of the preceding values. In some embodiments, the shape of the fluid through and/or around the flow generator and/or the electrodes is such that is such that the shape of the electric field across the electroporation chamber is relatively or sufficiently uniform. In some embodiments, the shape of the fluid through and/or around the flow generator and/or the electrodes allows one to match the flow characteristics with the applied electrical field.

In some embodiments, the flow generator serves as an effective means of introducing turbulence to the fluid, so as to effectively mix a particle and a microorganism. In some embodiments, this enhances the effectiveness of the electroporation. In some embodiments, the flow generator serves as an effective means of introducing pressure to the fluid. In some embodiments, this enhances the effectiveness of the electroporation. In some embodiments, the flow generator serves as an effective means of introducing heat to the fluid. In some embodiments, this enhances the effectiveness of the electroporation.

In some embodiments, the system can also be integrated with techniques for disinfection, such as a combination with an UV light source or other disinfecting or filtration methods.

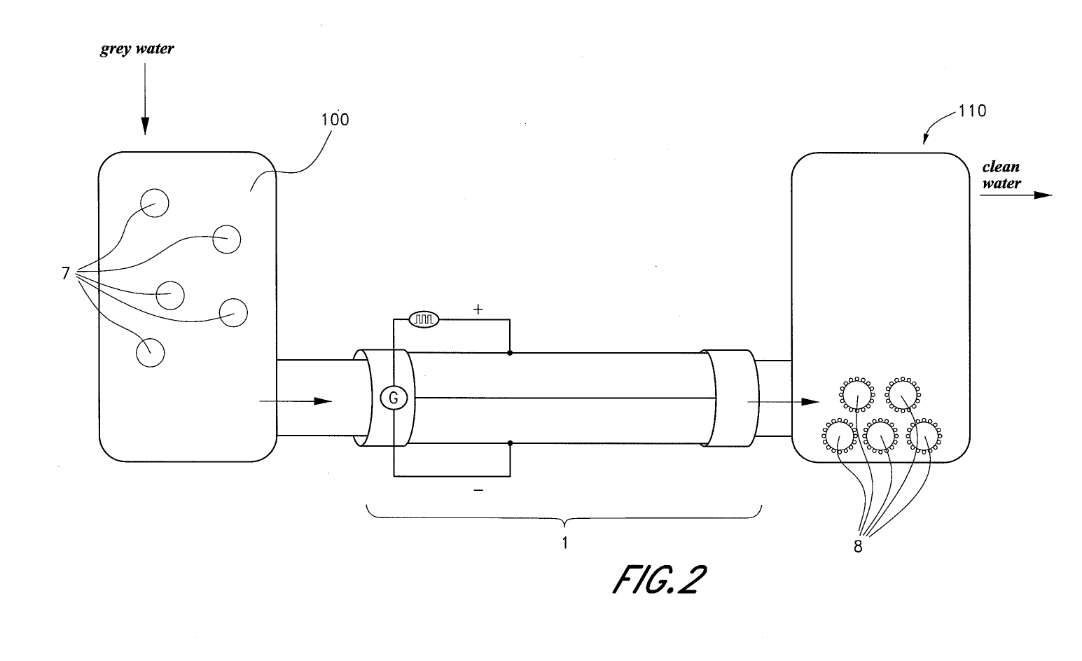

As shown in FIG. 2, in some embodiments, the device or the system 1 can be integrated with a bioreactor 100. The bioreactor 100 first encourages a growth of microorganisms or cells 7, which can be used, for example, to consume, metabolize, transform or otherwise modify a nutrient or a pollutant in order to sequester, reduce, render harmless or beneficial, or eliminate any undesired components as part of a more complex treatment system. In some embodiments, the fluid treatment system 1 is in fluid communication with the bioreactor 100 so that the treatment system 1 can serve as a secondary treatment process to elecroporate the organisms from the bioreactor 100. In some embodiments, the system further includes additional aspects for sedimentation or filtration 110 to further treat the fluid and remove or reduce a level of any dead or damaged cells 8.

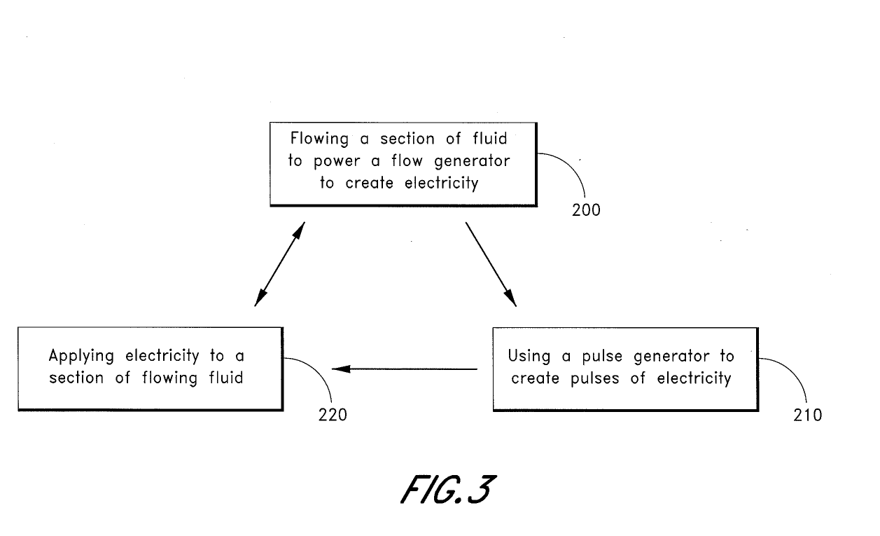

FIG. 3 depicts a flow chart outlining a general method for how a fluid treatment system can be employed. In some embodiments, the process can start with flowing a section of fluid to power the flow generator to create electricity (block 200). One can then use the pulse generator to create pulses of electricity (block 210). These pulses of electricity can then be applied to the section of the flowing fluid (block 220). In some embodiments, the moving section of fluid first generates electricity by powering the flow generator, and then that section of fluid enters the electroporation chamber and is subjected to the electrical pulse(s). In some embodiments, a stored charge is first administered to the section of flowing fluid (block 220), which then flows down the flow path to the electroporation chamber where it can supply energy to the flow generator to create electricity (block 200), for the next pulse to be administered (block 210).

One skilled in the art will appreciate that for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In some embodiments, the method for treating fluid involves flowing cell contaminated fluid through the generator to generate electrical power, using the pulse generator to transform the electrical power into the pulse of electricity, and applying a pulse of electricity to the fluid in a sufficient current and at a sufficient voltage to lyse and/or damage the cell, thereby treating the fluid. In some embodiments, the method for treating fluid involves flowing cell contaminated fluid through the generator to generate electrical power, using the pulse generator to transform the electrical power into the pulse of electricity, and applying a pulse of electricity to the fluid in a sufficient electrical field to lyse and/or damage the cell, thereby treating the fluid. In some embodiments, the section of fluid that generates the electrical power has the pulses of electricity applied to it. In some embodiments, a second and a third pulse of electricity is applied to the fluid. In some embodiments, a frequency of the pulse of electricity is determined by a flow rate of the flowing fluid. In some embodiments, an increase in the flow rate results in a greater frequency of the pulse and a decrease in the flow rate results in a lower frequency of the pulse. In some embodiments, at least two pulses of electricity having the voltage of at least 1 kV at 10 amps are applied to the fluid. In some embodiments, a faster flow rate can be used to generate a larger pulse for a given frequency. In some embodiments, at least two pulses of electricity having an adequate electrical field (e.g., 10 mV/cm to 50 kV/cm) at 10 amps are applied to the fluid.

In some embodiments, the method in FIG. 3 is a method for electrifying the fluid. In some embodiments, the method can involve providing any of the embodiments of the fluid treatment systems described herein, flowing fluid through the flow generator to generate the electrical potential, and applying the electrical potential to the anode and the cathode so as to generate one or more pulses of electricity across the fluid to electrify the fluid.

In some embodiments, the flow of fluid can be reversed. In some embodiments, the fluid treatment system can be positioned such that the electrodes (and the electroporation chamber) are upstream of the flow generator, such that fluid flowing though the system is first subject to electroporation and then comes into contact with the flow generator to generate electricity for the next pulse.

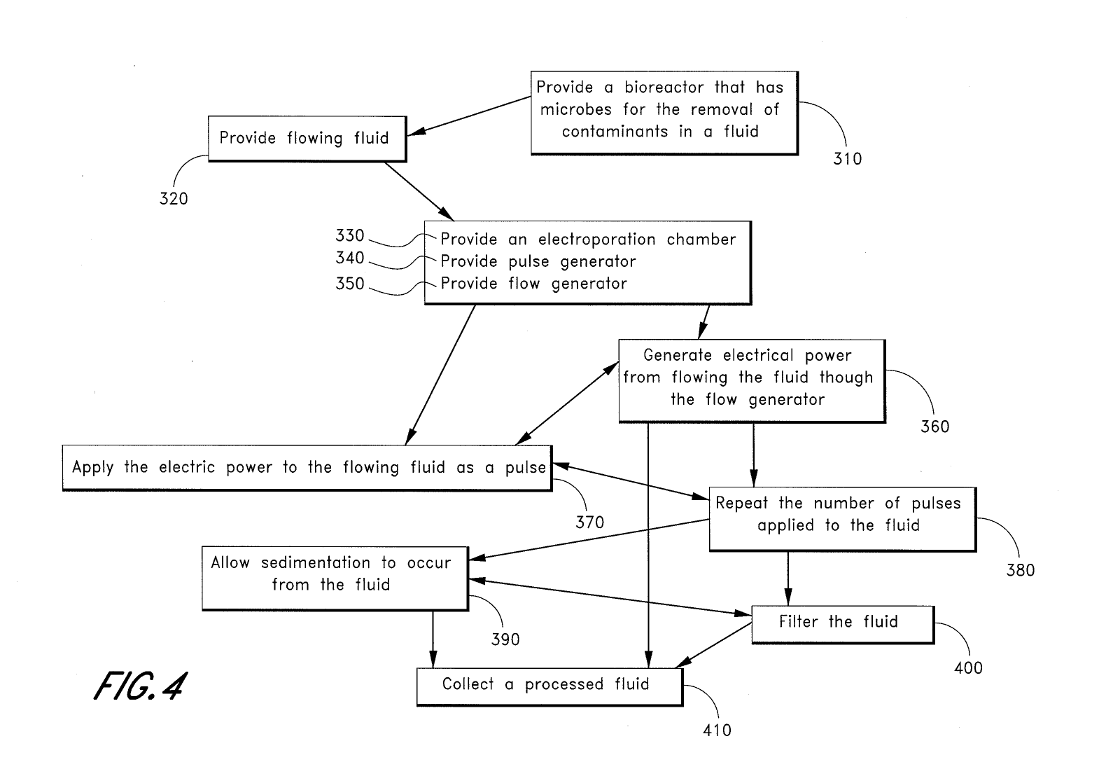

FIG. 4 depicts a flow chart depicting some embodiments for how a fluid treatment system can be employed. In some embodiments, one can provide the bioreactor that can include microbes for the removal of various contaminants in the fluid (block 310). One can then provide: the flowing fluid (either upstream of the bioreactor or downstream of it) (block 320), the electroporation chamber, the pulse generator and/or the flow generator (block 330, 340, and 350), to generate electrical power from the flowing fluid via the flow generator (block 360). One can then apply the generated electrical power to the flowing fluid as the pulse (block 370). One can then apply additional pulses to the fluid (block 380), which can then be followed with sedimentation (block 390) and/or filtering (block 400) to remove contaminants, which can include electroporated cells. Finally, one can collect the fluid (block 410). In some embodiments, one or more of the above processes may be removed, skipped, or repeated. In some embodiments, one may start at a lower position of the flow chart.

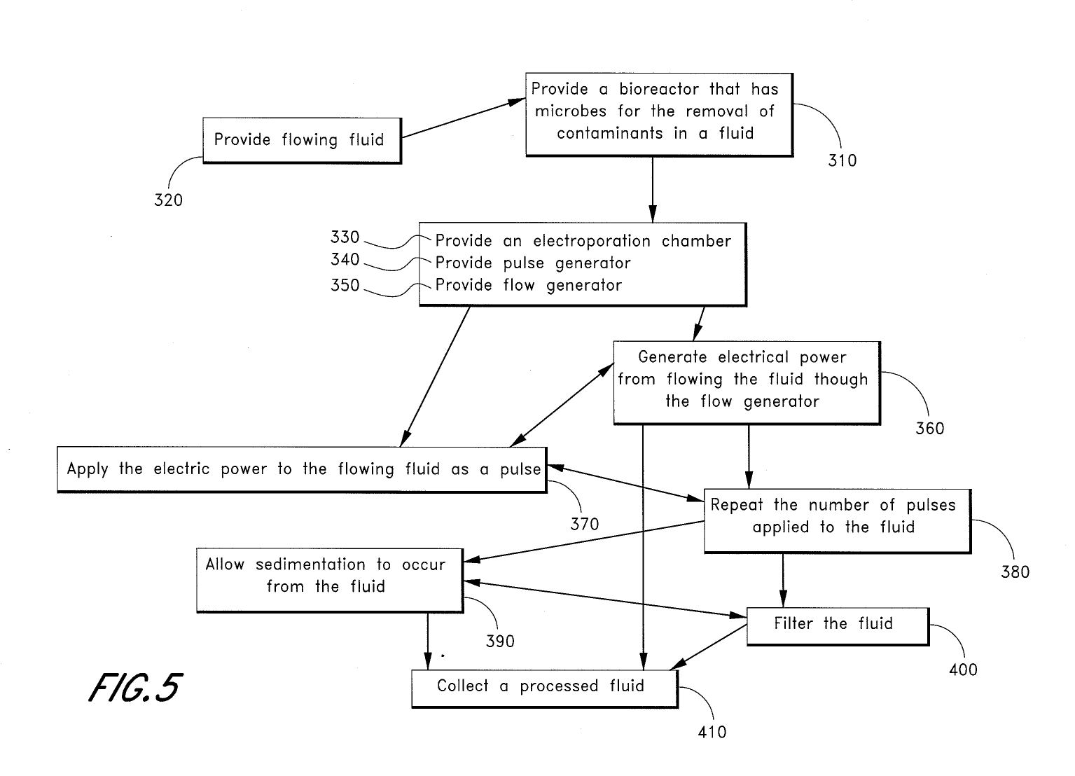

As shown in FIG. 5, some of the processes can be performed in alternative orders. In some embodiments, one first supplies the flowing liquid (block 320) into the bioreactor (block 310), and provides the electroporation chamber, the pulse generator, and the flow generator (block 330, 340, and 350). One can then apply electrical power to the fluid (block 370) (which could have been stored), and then generate electrical power from the flowing fluid (by the flow generator) for the next pulse (block 360).

In some embodiments, the fluid flows into the provided electroporation chamber first and then into the flow generator, such that fluid flowing through the flow generator has already been subjected to electroporation. In some embodiments, the fluid flows into the provided flow generator first, and then into the electroporation chamber, such that a first section of fluid can both power a generator and receive the electrical pulse. In some embodiments, the fluid to which the electrical pulse is applied is not flowing but has been stopped to allow for multiple pulses to be administered to the fluid.

In some embodiments (as shown in FIGS. 1 and 2) the parts of the device are associated into a single device. However, in some embodiments, the device is provided in a kit form or in the system form, where the apparatus need not be physically assembled together (but rather just configured so as to allow the appropriate associations). In some embodiments, the kit is provided that includes the flow generator, the pulse generator, the anode in electrical communication with the flow generator (or configured to be capable of being in electrical communication with the flow generator) and the cathode in electrical communication with the flow generator (or configured to be capable of being in electrical communication with the flow generator). In some embodiments, the electricity in the anode and/or cathode is controlled by the pulse generator. In some embodiments, the flow generator and pulse generator are configured so as to provide a pulse of electricity. In some embodiments, the pulse is at least 1 kV at 10 Amps. In some embodiments, the anode and/or the cathode are metal plates that are sized to fit into a water pipe and occupy some of the flow path.

In some embodiments, to electroporate or otherwise treat a cell, the pulse establishes an electric field which is greater than or equal to the threshold (e.g., E>Eₜₕ). In some embodiments, this is greater than Eᵢᵣ, which is the irreversible threshold (although this is not required for all embodiments). While microcurrents may play a role in electroporation, the ability of a electroporation chamber to electroporate a cell can be described in terms of the external electric field applied to cells in a chamber. In some embodiments, the electric field that is applied is between 1 mV and 500 kV per meter. In some embodiments, the electric field applied is between 10 mV/cm to several V/cm, a range that can be beneficial when cell stimulation (instead of electroporation) is desired. In some embodiments, for example, the electric field can be 10, 20, 30, 40, 50, 60, 70, 80, 100, 200, 300, 500, 1,000, 2,000, 3,000, 4,000, 5,000, 6,000, 7,000, 8,000, 9,000, or 10,000 millivolts per centimeter, including any range greater than any of the preceding values, as well as any range defined between any two of the preceding values. In some embodiments, the electric field applied is between 100 volts per centimeter and 100,000 volts per centimeter (for example, when a field that is more useful for irreversible electroporation is desired). In some embodiments, the electric field can be, for example 200, 500, 1,000, 5,000, 10,000, 15,000, 20,000, 25,000, 30,000, 35,000, 40,000, 45,000, 50,000, 60,000, 70,000, 80,000, 90,000, or 99,000 volts per centimeter, including any range greater than any of the preceding values, as well as any range defined between any two of the preceding values. In some embodiments, the cathode and/or anode and/or flow generator and/or pulse generator is configured to supply the above noted strengths of electric fields to a fluid as described herein.

### Further Variations and Additional or Alternative Embodiments

In some embodiments, the system and/or the device is configured to allow for retrofitting existing grey water systems and/or for new construction. In some embodiments, the system and/or the device is configured for domestic applications. In some embodiments, the system and/or the device is configured for industrial applications.

In some embodiments, one or more of the methods or the devices described herein can provide an in-line solution for water treatment. In some embodiments, one or more of the methods or the devices described herein can allow for the retrofitting of existing fluid systems. In some embodiments, one or more of the methods or the devices described herein can provide for effective disinfection without the need for an additional reagent. In some embodiments, one or more of the methods or the devices described herein can provide for a self-contained, a self-renewing, and/or a self-powered system. In some embodiments, one or more of the methods or the devices described herein can be modulated for different conditions (e.g. flow, turbidity, use of water). In some embodiments, one or more of the methods or the devices described herein can be integrated with existing systems.

### Electroporation Chamber

In some embodiments, the electroporation chamber includes two parts of the pipe so as to form the flow path in the shape of the pipe. In some embodiments, the electroporation chamber is open to the atmosphere so that the fluid in the electroporation chamber is exposed to the atmosphere, such as in an aqueduct, canal, trough, etc.

In some embodiments, the pipe is a cylinder. In some embodiments, the chamber (which can be a pipe) is rectilinear. In some embodiments, the chamber has a first set of opposing walls and a second set of opposing walls. The first set of opposing walls is wider than the second set of opposing walls. In some embodiments, the wider set of opposing walls is the anode and/or the cathode, and the narrower set of opposing walls can serve to insulate the anode wall from the cathode wall. In some embodiments, the narrower set of walls includes a nonconducting material or includes a nonconducting section. In some embodiments one of the narrower walls is positioned on the “bottom” (side closest to the Earth). In some embodiments one of the wider walls is positioned on the “bottom”.

In some embodiments, the interior of the electroporation chamber is defined by a first inner surface that includes the anode and a second inner surface that includes the cathode. In some embodiments, the electroporation chamber defines an outer surface of the flow path through which the fluid flows and in which the anode or the cathode are positioned within the flow path.

In some embodiments, an exterior of the electroporation chamber (and/or the anode and the cathode) includes a nonconducting shell to insulate the system from external grounding. In some embodiments, the electroporation chamber (and/or the anode and the cathode) are separated from other structures that might short the system undesireably.

In some embodiments, the electroporation chamber is level. In some embodiments, the electroporation chamber has a proximal end and a distal end. In some embodiments, the distal end of the electroporation chamber is lower than the proximal end of the electroporation chamber. In some embodiments, the electroporation chamber includes the proximal end and the distal end, and the distal end of the electroporation chamber is higher than the proximal end of the electroporation chamber. In some embodiments, the flow path through the electroporation chamber and the flow generator is level. In some embodiments, the flow path through the electroporation chamber and the flow generator has a proximal end and a distal end. In some embodiments, the distal end is lower than the proximal end of the flow path through the electroporation chamber and the flow generator. In some embodiments, the distal end is higher than the proximal end of the flow path through the electroporation chamber and the flow generator. As will be appreciated by those of skill in the art, in light of the present disclosure, in embodiments in which a downstream section of the device and/or system is higher than an upstream section, a flowing fluid can still cause the device to function as long as the fluid has enough energy to make it over an elevated section.

In some embodiments, an amount that the fluid is treated depends upon the type of fluid (e.g., the types of contaminants suspected of being inside the fluid). In some embodiments, electroporation is such that less than 100 percent of the cells and/or organisms are living once electroporation is done. In some embodiments, electroporation is such that less than 100 percent of the cells and/or organisms are able to reproduce or replicate once electroporation is done. In some embodiments, less than, for example, 99.999, 99.99, 99.9, 99, 98, 97, 96, 95, 93, 92, 91, 90, 85, 80, 75, 70, 65, 60, 55, 50, 45, 40, 35, 30, 25, 20, 15, 10, 9, 8, 7, 6, 5, 4, 3, 2, 1, 0.1, 0.01, or 0.001 of the cells and/or microorganisms are living or are able to reproduce or replicate once electroporation is done, including any range less than any of the preceding values and any range defined between any two of the preceding values. In some embodiments, the above ranges and percents apply to the cells in a fluid that are exposed to the electric field. In some embodiments, the above percentages are achieved with one or more pulses, for example: 2, 3, 4, 5, 6, 7, 8, 9, 10, 15, 20, 25, 30, 35, 40, 50, 60, 70, 80, 90, 100 or more pulses, including any range more than any of the preceding values and any range defined between any two of the preceding values. In some embodiments, the number of pulses can depend upon the application, the type and amount of contamination, the makeup of the fluid, the flow rates, the energy delivered, etc.

In some situations, a volume of fluid processed is limited by a size of the piping. In some embodiments, the larger the piping, the larger an electrical system can be to sustain the output, which is not unlike a pulsed radar system. In a juice type application, 10 microsecond pulses are applied in up to eight successive chambers as the juice passes by. With a short pulse duration, there is no or minimal heating effect. In some embodiments, the devices and methods described herein can be applied in microfluidic applications.

In some embodiments, the chamber can be narrow so as to provide superior benefits to the flow generator (e.g., faster flowing fluid, generating more electricity) as well as the effectiveness electroporation chamber (Eₜₕ is V/cm, so the smaller the distance across, the greater the effectiveness and/or efficiency of the device). In some embodiments, the shape of the electroporation chamber can be optimized to allow for even distribution of the electric field across the chamber, or at least to match the flow characteristics of the fluid.

### Anode and Cathode

In some embodiments, the anode and/or the cathode are the outer surface that defines the flow path, such as the piping shown in FIG. 1. In some embodiments, the anode and/or the cathode are plates, wires, rods, screens, or other structures that are positioned within the flow path. In some embodiments, the anode is a structure (such as a plate, wire, or rod) that is positioned within the flow path of the fluid, while the cathode is an interior surface that defines the flow path (such as the inside of a pipe). In some embodiments, the cathode is the structure (such as a plate, wire, or rod) that is positioned within the flow path of the fluid, while the anode is the interior surface that defines the flow path (such as the inside of a pipe).

In some embodiments, the anode and/or the cathode are of metal or other conducting material. In some embodiments, the anode and/or the cathode are made of steel, copper, titanium, aluminum, or any combination thereof.

In some embodiments, the anode and/or the cathode are configured so as to have a reduced impact on the flow of the fluid through the system (such as when they are a smooth pipe surface).

In some embodiments, the anode and/or the cathode are integrated into the flow generator. In some embodiments, the anode is, or is part of, the structure that moves from the fluid flow in the flow generator (such as the blades) and the cathode is a separate part or part of the piping. In some embodiments, the cathode is or is part of the structure that moves from the fluid flow (such as the blades) in the flow generator and the anode is a separate part or part of the piping.

In some embodiments, the anode is separated from the cathode by an insulating section. In some embodiments, the insulating section is a space or air. In some embodiments, the insulating section is a nonconducting material, such as rubber or plastic. In some embodiments, the insulating material allows for a fluid tight connection between the anode and the cathode to effectively create an enclosed flow path through which the fluid can flow. In some embodiments, the insulating material is resistant to the electrical and the chemical environment present at this point in the device.

In some embodiments, the anode and the cathode are spaced apart such that a bottom half of the flow path includes the anode or the cathode and a top half of the flow path includes the corresponding cathode or anode. Thus, in such embodiments, the potential difference is across the piping, in a direction perpendicular to the flow of fluid. In some embodiments, the anode (or the cathode) is placed at a first point in a pipe and the cathode (or anode) is placed up or down stream, such that the potential difference occurs in the direction of flow of the pipe.

In some embodiments, more than one electroporation chamber and/or anode/cathode pairing is used in the treatment system. In some embodiments, a single flow generator can supply power to one or more anode/cathode pairs. In some embodiments, each anode/cathode pairing has its own flow generator.

In some embodiments, the electricity generator itself and the shell of the pipe around it comprise the anode/cathode pairing. For example, the wheel can be the anode/cathode while the pipe is the cathode/anode. In some embodiments, the generator can be arranged so that the field is present in the system itself as the fluid transfers through it.

### Pulse Generator

In some embodiments, the pulse generator 20 is separate from the flow generator and/or the anode and/or the cathode, but is in electrical communication with such components. In some embodiments the electrical communication is achieved via a wire.

In some embodiments, the pulse generator is configured to provide an electric field between 10 mV/cm to several V/cm, a range that can be beneficial when cell stimulation (instead of electroporation) is desired. In some embodiments, for example, the pulse generator is configured to provide an electric field of 10, 20, 30, 40, 50, 60, 70, 80, 100, 200, 300, 500, 1,000, 2,000, 3,000, 4,000, 5,000, 6,000, 7,000, 8,000, 9,000, or 10,000 millivolts per centimeter, including any range greater than any of the preceding values, as well as any range defined between any two of the preceding values. In some embodiments, the pulse generator is configured to provide an electric between 100 volts per centimeter and 100,000 volts per centimeter (for example, when a field that is more useful for irreversible electroporation is desired). In some embodiments, the electric field can be, for example 200, 500, 1,000, 5,000, 10,000, 15,000, 20,000, 25,000, 30,000, 35,000, 40,000, 45,000, 50,000, 60,000, 70,000, 80,000, 90,000, or 99,000 volts per centimeter, including any range greater than any of the preceding values, as well as any range defined between any two of the preceding values. In some embodiments, the pulse generator is configured to provide the voltage of at least 0.1 kV across the electroporation chamber. For example, in some embodiments, the device is configured to provide 0.2, 0.3, 0.5, 0.7, 0.9, 1, 2, 3, 4, 5, 6, 7, 8, 9, 10, 11, 12, 15, 20, 30 kV or more, including any range above any of the preceding values and any range defined between any two of the preceding values. In some embodiments, this is the voltage that is delivered on average across the electroporation chamber. In some embodiments, the pulse generator is configured to provide at least 1 ampere of current across the electroporation chamber. In some embodiments, this can be, for example, 2, 3, 4, 5, 6, 7, 8, 9, 10, 11, 12, 13, 14, 15, 20, 25, 30, 40 amperes or more, including any range above any of the preceding values and any range defined between any two of the preceding values. In some embodiments, the pulse generator is configured such that any of the preceding electric field strengths and/or voltage ranges can be achieved with any of the preceding current values. In some embodiments, the electric field strength is between 10 mV/cm and 50 kV/cm and/or the voltage is between about 1 to 10 kV and the current is between about 5-15 amperes (such as 10 amperes). In some embodiments, it is the combination of the flow generator and the pulse generator that is configured to achieve the above electric field, current, and voltage ranges. In some embodiments, it is the combination of the anode and/or the cathode and the pulse generator that is configured to achieve the above electric field, current, and voltage ranges. In some embodiments, it is the combination of the flow generator, the anode and/or the cathode and the pulse generator that is configured to achieve the above electric field, current, and voltage ranges. In some embodiments, the system and/or the device is configured so that, when operating, it can achieve the above noted ranges for electric field, current, and voltage.

In some embodiments, the pulse generator is configured to provide pulses at the frequency and the duration such that multiple pulses are provided to a section of fluid as the section of fluid flows through the electroporation chamber. In some embodiments, the pulse generator includes the capacitor.

In some embodiments, the system, the pulse generator, the flow generator, or any combination thereof, is configured to deliver an AC current between the cathode and the anode. In some embodiments, the system, the pulse generator, the flow generator, or any combination thereof, is configured to deliver a DC current between the cathode and the anode.

### Flow Generator

In some embodiments, any fluid driven flow generator can be employed. In embodiments in which energy is to be derived from the flowing liquid, the flow generator may include a liquid suitable appropriate interaction surface (such as a plastic, rubber, wood, or metal wheel or blades). In some embodiments, the flow generator is in electrical communication with the pulse generator and/or the anode and/or the cathode. In some embodiments, the flow generator is an impulse turbine. In some embodiments, the flow generator is a Pelton turbine, a Francis turbine, and/or a Kaplan turbine.

In some embodiments, the flow generator is connected to the cathode by a wire or lead 11 and/or the flow generator is connected to the anode by a wire or lead 12. In some embodiments, the wire or lead 11 passes through the pulse generator. In some embodiments, the wire or lead 12 passes through the pulse generator.

### Additional Components

As noted above, in some embodiments, additional components can be included in the device or the system. In some embodiments, the bioreactor or other device is included up stream of the electroporation chamber. In some embodiments, the system or the device includes a filter. In some embodiments, the system or the device includes the sedimentation tank. In some embodiments, the capacitor is provided in electrical communication with the flow generator and/or the pulse generator and/or the anode and/or the cathode. In some embodiments, a battery is provided in electrical communication with the flow generator and/or the pulse generator and/or the anode and/or the cathode. In some embodiments, the device or system also includes the UV light source that can optionally be electrically connected to the flow generator.

In some embodiments, a deionising resin is located upstream of the electroporation chamber.

In some embodiments, the present methods and/or devices and/or systems can be used where there are solutions that are highly osmotic. In some such embodiments, the salt can enter cells when there is permeabilisation of the membrane and lead to a rupture of the cell. In some embodiments, the present methods, systems and/or devices can be attached so as to process washing machine wastewater. In some embodiments, the salts can increase the conductivity of the solution. In some embodiments, the present methods and/or devices and/or systems can be used on a fluid that has calcium, which is a salt that can cause cell death when cells have a large influx, even in the absence of complete cell rupture.

In some embodiments, additional additives (or sources thereof) that can be included can include biocides or other agents which inhibit cell growth. In some embodiments, additional additives (or sources thereof) that can be included can include the following: osmotic agents, calcium, hypertonic additives, biocidal additives, microbe growth inhibiting additives or any combination thereof.

In some embodiments, a filter system can be employed upstream or downstream of the flow generator.

### Fluid

In some embodiments, the fluid is grey water. In some embodiments, the fluid is stream water. In some embodiments, the fluid is water. In some embodiments, the fluid includes the microorganism or is suspected of including the microorganism. In some embodiments, the fluid is treated via electroporation even if it does not, or is not known to, include the microorganism. In some embodiments, the fluid is a fluid that is naturally located above sea-level. In some embodiments, the fluid is a fluid that has potential and/or kinetic energy. In some embodiments, the fluid is a fluid that naturally has potential and/or kinetic energy. In some embodiments, the fluid is not a fluid that must be raised or pumped up in order for it to have potential and/or kinetic energy. In some embodiments, the fluid does not need to be raised or pumped up in order for it to have potential and/or kinetic energy.

In some embodiments, the fluid is waste water. In some embodiments, the fluid comes from a residential spout or tap from a home spigot or sink. In some embodiments, the device or system is configured to screw onto an end of a spigot in a residential environment.

In some embodiments, the fluid is within the electroporation chamber. In some embodiments, the fluid is within the flow generator. In some embodiments, the fluid within the electroporation chamber is a same body of fluid as the fluid in the flow generator.

In some embodiments, the fluid contains the cell or the microorganism. In some embodiments, the cell is or is part of the microorganism, a parasite, a bacteria (such as E. coli), a plant cell, a nonhuman cell, or a pathogenic cell.

In some embodiments, the flow path through which the fluid flows is level (and thus the fluid flows under pressure). In some embodiments, the flow path through which the fluid flows is uphill (and thus the fluid flows under pressure). The pressure can be provided before the system (such as through a previous downhill section) or by negative pressure—e.g., siphoning, provided after the system. In some embodiments, the flow path through which the fluid flows is downhill (and thus the fluid flows under gravity).

In some embodiments, the fluid is a gas and the electroporation treats an airborne bacteria or an airborne cell. In such embodiments, the flow generator can be a wind turbine and the air that passes through the turbine is also treated in the electroporation chamber. In some embodiments, the flow generator can be a wind turbine that includes a duct that directs the air into the electroporation chamber.

The terms “treat” or “treatment” do not require complete removal of all cell and/or membrane contaminants in the fluid. In some embodiments, following the treatment, there will be fewer living cells or organisms, or the cells or organisms will be left in a weakened state (which may later result in death or an inability to replicate or reproduce). Of course, in some embodiments, the remnants of the cells will remain in the fluid.

### EXAMPLES

### Example 1

The fluid treatment system that includes the flow generator, the pulse generator, and the electroporation chamber, in which the top half of the chamber is the cathode and the bottom half of the chamber is the anode, is provided. The chamber is cylindrical and has an interior diameter that is approximately the same size as an interior diameter of the piping in the waste water fluid system it is to be placed into. A section of the piping in the waste water fluid system is cut out and replaced with the fluid treatment system.

Waste water is allowed to flow first through the flow generator and the water is allowed to continue to flow into the electroporation chamber. The water is subjected to 5 lkV pulses of at least 10 amperes of current. The electricity for the pulses is created by the flow generator and applied in pulses by the pulse generator. The treated water will have fewer viable cells in it.

### Example 2

The fluid treatment system including the electroporation chamber, the flow generator, and the pulse generator is provided. The electroporation chamber is connected to the pulse generator so that the pulse generator can control the electricity applied to the electroporation chamber. The electroporation chamber includes an open air aquaduct arrangement, in which water flows downhill. The electroporation chamber includes the surface of a flow path of the aquaduct and a first metal plate that is connected to the pulse generator and can serve as the anode and a second metal plate that is connected to the pulse generator and can serve as the cathode. The first and the second metal plates are placed upstream of the flow generator. Water flowing through the aquaduct powers the flow generator, which supplies power to the pulse generator, which generates 5-10 electrical pulses across water that is flowing upstream from the flow generator. The pulse treated water then flows down the aquaduct, supplying power to the flow generator for the subsequent round of treatment on a new upstream section of water.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g.,“a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A fluid treatment system comprising:
an electroporation chamber comprising an anode and a cathode configured to provide an electrical potential within or across the electroporation chamber; and
a flow generator in fluid communication with the electroporation chamber, wherein the flow generator generates electricity by movement of a fluid, and wherein the flow generator is electrically coupled to the anode and to the cathode to provide the electricity for the electrical potential.

2. The fluid treatment system of claim 1, further comprising a pulse generator, wherein the pulse generator is electrically coupled to: a) the flow generator, b) the anode, and c) the cathode.

3. The fluid treatment system of claim 2, wherein the pulse generator and the flow generator are configured to provide an electric field of at least 10 mV/cm.

4. The fluid treatment system of claim 2, wherein the pulse generator and the flow generator are configured to provide an electric field between 1 kV/cm and 100 kV/cm.

5. The fluid treatment system of claim 2, wherein the pulse generator and the flow generator are configured to provide at least 10 amperes of current across the electroporation chamber.

6. The fluid treatment system of claim 2, wherein the pulse generator is configured to provide pulses at a frequency and duration such that multiple pulses are provided to a section of fluid as the section of fluid flows through the electroporation chamber.

7. The fluid treatment system of claim 1, wherein the electroporation chamber comprises a pipe.

8. The fluid treatment system of claim 7, wherein the pipe comprises a cylinder.

9. The fluid treatment system of claim 1, wherein an interior of the electroporation chamber is defined by a first inner surface comprising the anode and a second inner surface comprising the cathode.

10. The fluid treatment system of claim 1, wherein the anode is separated from the cathode by an insulating section.

11. The fluid treatment system of claim 1, wherein the electroporation chamber defines an outer surface of a flow path through which a fluid flows and wherein the anode or the cathode are positioned within the flow path.

12. The fluid treatment system of claim 11, wherein the anode is a wire or a metal plate within the flow path, and wherein the cathode is a surface of the electroporation chamber.

13. The fluid treatment system of claim 11, wherein the cathode is a wire or a metal plate within the flow path and wherein the anode is a surface of the electroporation chamber.

14. The fluid treatment system of claim 1, further comprising a capacitor.

15. The fluid treatment system of claim 14, wherein the capacitor is part of a pulse generator.

16. The fluid treatment system of claim 1, further comprising a UV light source, wherein the light source is electrically connected to the flow generator.

17. The fluid treatment system of claim 1, further comprising a fluid within the electroporation chamber.

18. The fluid treatment system of claim 17, further comprising a fluid within the flow generator.

19. The fluid treatment system of claim 18, wherein the fluid within the electroporation chamber is a same body of fluid as the fluid in the flow generator.

20. The fluid treatment system of claim 1, wherein the electroporation chamber contains grey water.

21. The fluid treatment system of claim 1, further comprising a sedimentation chamber in fluid communication with the electroporation chamber.

22. The fluid treatment system of claim 1, wherein the anode, the cathode, or the anode and the cathode comprises titanium, aluminum, copper, or any combination thereof.

23. The fluid treatment system of claim 1, further comprising a deionising resin located upstream to the electroporation chamber.

24. The fluid treatment system of claim 1, wherein the fluid comprises osmotic agents, calcium, hypertonic additives, biocidal additives, microbe growth inhibiting additives, or any combination thereof.

25. The fluid treatment system of claim 1, wherein the system is configured to deliver DC current between the cathode and the anode.

26. The fluid treatment system of claim 1, wherein the electroporation chamber further comprises an exterior nonconducting shell.

27. The fluid treatment system of claim 1, wherein the electroporation chamber is level.

28. The fluid treatment system of claim 1, wherein the electroporation chamber comprises a proximal end and a distal end, and wherein the distal end of the electroporation chamber is lower than the proximal end of the electroporation chamber.

29. The fluid treatment system of claim 1, wherein the electroporation chamber comprises a proximal end and a distal end, and wherein the distal end of the electroporation chamber is higher than the proximal end of the electroporation chamber.

30. (canceled)

31. A method for treating water, the method comprising:
flowing water through a generator to generate electrical power, wherein the water contains a cell;
using a pulse generator to transform the electrical power into a pulse of electricity; and
applying the pulse of electricity to the water in a sufficient current and at a sufficient voltage to lyse the cell, thereby treating the water.

32. The method of claim 31, wherein the section of water that generates the electrical power has the pulses of electricity applied to it.

33. The method of claim 31 further comprising applying a second and a third pulse of electricity.

34. The method of claim 31, wherein a frequency of the pulse of electricity is determined by a flow rate of the flowing water, wherein an increase in the flow rate results in a greater frequency of the pulse and wherein a decrease in the flow rate results in a lower frequency of the pulse.

35. The method of claim 31, wherein at least two pulses of electricity having a voltage of at least 1 kV at 10 amps are applied to the water.

36. A method of electrifying water, the method comprising:
providing a flow powered electroporation device, the device comprising:
an electroporation chamber comprising an anode and a cathode configured to provide an electrical potential within or across the electroporation chamber; and
a flow generator in fluid communication with the electroporation chamber, wherein the flow generator generates electricity by movement of a fluid, and wherein the flow generator is electrically coupled to the anode and to the cathode to provide the electricity for the electrical potential;
flowing water through the flow generator to generate the electrical potential; and
applying the electrical potential to the anode and the cathode so as to generate one or more pulses of electricity across the water, thereby electrifying the water.
